(19) United States
(12) Patent Application Publication
(10) Pub. No.: US 2010/0044288 A1
(43) Pub. Date: Feb. 25, 2010

(54) COLUMN TEMPERATURE MONITORING APPARATUS AND CHROMATOGRAPHIC APPARATUS

(75) Inventor: Takaei Kitagawa, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: Shimadzu Corporation, Nakagyo-ku (JP)

(21) Appl. No.: 12/542,417

(22) Filed: Aug. 17, 2009

(30) Foreign Application Priority Data
Aug. 19, 2008 (JP) 2008-210222

(51) Int. Cl. B01D 15/12; G01K 13/00

(52) U.S. Cl. 210/149; 374/141; 374/E13.001

(57) ABSTRACT

A column temperature monitoring apparatus is provided in which the analysis reproducibility and analysis accuracy are improved by increasing the accuracy of the control of a column temperature. A sensor unit 10 is attached to a column 4 in such a manner that a temperature sensor 11 touches the outer surface of the column 4, and the temperature data read by the temperature sensor 11 is provided to a temperature controlling/processing unit 20 provided in a constant temperature bath 5 via a wired or wireless communication path 30. The temperature controlling/processing unit 20 temperature-controls the column by controlling the heating current supplied to a heater 51 so that the actually obtained column temperature reaches the target temperature indicated from the controller/processor 7. In the column temperature monitoring apparatus according to the present invention, a temperature controlling is performed based not on the temperature of air inside the constant temperature bath or a heat block but on the temperature of the outer surface of the column, which enhances the accuracy of the column temperature's detection.

The present invention relates to a column temperature monitoring apparatus for temperature-controlling the column of a liquid chromatograph and gas chromatograph, and a chromatographic apparatus using the column temperature monitoring apparatus.

### BACKGROUND OF THE INVENTION

In a liquid chromatograph (LC) analysis, the component retention property of a column, the viscosity of a mobile phase, and other properties are influenced by the temperature. Hence, it is important to keep the column temperature constant in order to achieve a high reproducibility of analyses. In addition, the accuracy of a column temperature control is important in order to ensure the sameness of the analysis results (i.e. chromatograms) obtained on the same sample through a plurality of LC apparatuses. Given such factors, in an LC analysis (in particular, a high-performance liquid chromatography (HPLC) analysis which is now a mainstream), a constant temperature bath is generally used for controlling the temperature of a column.

The temperature controlling method of a constant temperature bath roughly includes: a heat block method, air circulation method, and liquid circulation method. In the heat block method, a metal block having a high heat conductivity, such as aluminum, and firmly attached to a column is temperature-controlled by a heater or other apparatus. In the air circulation method, the air heated by a heater is stirred by a fan to temperature-control the air inside a constant temperature bath containing a column. In the liquid circulation method, a liquid such as water is used as a heating medium in place of the air in the air-circulating constant temperature bath.

Whichever temperature controlling method of a constant temperature bath is used, a column temperature controlling is performed by monitoring the current temperature with a temperature sensor and regulating the electric power for heating supplied to a heater in accordance with the current temperature. In a constant temperature bath of an air circulation method, generally a temperature sensor is provided for detecting the temperature of the air inside of the constant temperature bath, and a control is performed based on the temperature detected by the temperature sensor. In a constant temperature bath of a heat block method, generally a temperature sensor is provided for detecting the temperature of the metal block, and a control is performed based on the temperature detected by the temperature sensor.

However, the object to be kept at a constant temperature or to be set at a predetermined temperature is the temperature of the column; to be more exact, it is the internal temperature of the column. On the other hand, the temperature which is actually detected by the temperature sensor is the temperature of the air inside a constant temperature bath and the temperature of a metal block. Hence, conventionally, a temperature control is performed after the thermal conductivity (e.g. thermal response delay) of the air or the metal block has been supposed in advance: however, in practice, the difference between the temperature of the air inside a constant temperature bath or a metal block and the column temperature may be more than a previously-supposed state, which might impair the accuracy of the column temperature control.

In the air circulation method, with a large difference between the temperature inside a constant temperature bath and the room temperature, the temperature of the mobile phase flowing into a column is low, which may distort a peak or peaks in a chromatogram due to a temperature gradient developed inside of the column. Therefore, a pre-heat unit is sometimes provided before the column in order to raise the temperature of the mobile phase in advance (refer to Patent Document 2). Even in this configuration, an insufficient pre-heating deteriorates the analysis accuracy: whether or not the pre-heating is sufficient is required to be experimentally judged based on the temperature of the air inside a constant temperature bath, room temperature, and other factors. Accordingly, a misjudge leads to an insufficient pre-heating and may deteriorate the analysis accuracy.

Patent Document 1: Japanese Unexamined Patent Application Publication No. 2005-140592

Patent Document 2: Japanese Unexamined Patent Application Publication No. 2005-140505

### SUMMARY OF THE INVENTION

The present invention has been achieved in view of the aforementioned problems, and the main objective thereof is to provide a column temperature monitoring apparatus and chromatographic apparatus capable of accurately detecting the column temperature and thereby performing more accurate column temperature control than ever before to enhance the analysis reproducibility and analysis accuracy. Another objective of the present invention is to provide a column temperature monitoring apparatus and chromatographic apparatus capable of accurately detecting the difference between the temperature inside a constant temperature bath and the column temperature, and appropriately adjusting the length of a pre-heating path for example to enhance the analysis reproducibility.

The present invention achieved to solve the aforementioned problems provides a column temperature monitoring apparatus for controlling the temperature of a column of a liquid chromatograph or a gas chromatograph, including:

a) a sensor unit directly attached to an outer surface of the column and including a temperature detection unit for obtaining temperature information corresponding to a temperature of the outer surface of the column;

b) a processor provided at a position distant from the sensor unit, for processing the temperature information obtained by the temperature detection unit; and

c) an information transmission unit for connecting the sensor unit and the processor by wire or wirelessly.

In the column temperature monitoring apparatus according to the present invention, the sensor unit is directly attached to the column in such a manner that the temperature detection unit such as a thermistor for example is in contact with the outer surface of the column. Therefore, unlike conventional methods, the temperature detection unit directly obtains the temperature of the column albeit that of the outer surface. Preferably, the sensor unit may also include a reading unit for reading the temperature information obtained by the temperature detection unit and converting the temperature information into an electric signal in accordance with the temperature. The reading unit may include an A/D converter for converting the electric signal in accordance with the temperature into a digital value.

On the other hand, the processor connected to the sensor unit via the information transmission unit is provided at a position distant from the sensor unit. In the case where the column temperature monitoring apparatus according to the present invention includes a constant temperature bath in which the column is contained, the processor may be provided in the constant temperature bath. The processor may include a control circuit for controlling a heating current supplied to a heating unit for heating the space inside the constant temperature bath in such a manner that the temperature information obtained by the sensor unit for example reaches a target temperature. The processor may include a display unit for displaying the temperature information obtained by the sensor unit as a numerical value for example.

As an embodiment of the column temperature monitoring apparatus according to the present invention, the sensor units may be provided in a plurality, and a processor may be commonly provided for the plurality of sensor units. In this case, the plurality of sensor units are usually attached at positions distant from each other in the longitudinal direction of the column. This makes it possible to detect the gradient of column temperature in the longitudinal direction of the column, i.e. in the direction of the flow of the mobile phase.

In the column temperature monitoring apparatus according to the present invention, the sensor unit may include a holding unit for fixing the sensor unit on an existing column in such a manner that the temperature detection unit is in contact with the outer surface of the column. This facilitates a later attachment of the sensor unit to the column that a user has already bought. The holding unit may mechanically hold the body of the column, or make the sensor unit adhere to the column's outer surface.

As an embodiment, the column temperature monitoring apparatus according to the present invention may include an information retention unit, integrated with the sensor unit, that retains column identification information for specifying a column. As disclosed in Japanese Unexamined Patent Application Publication No. 2004-85357, the column identification information can be an ID unique to each column, and by using this ID, the column's usage history or other information can be managed.

The information transmission unit may use a wire or wireless connection: however, particularly in the case where the sensor unit is provided in a plurality, a wireless connection is preferable to eliminate cumbersome wirings. In particular, as a preferable embodiment, a short-distance wireless connection using a radio frequency identification (RFID) tag may be used.

As a particularly preferable embodiment of the column temperature monitoring apparatus according to the present invention, a temperature sensor RFID tag in which a temperature sensor and an RFID tag are integrated may be used as a sensor unit, and an LSI (large-scale integration) or the like may be mounted on the processor for communicating with this RFID tag. Japanese Unexamined Patent Application Publication No. H10-289297 discloses an RFID tag (or contactless data carrier) in which a temperature sensor is mounted, and Japanese Unexamined Patent Application Publication No. 2005-327104 discloses an RFID tag capable of easy connection with a temperature sensor. In particular, the usage of a passive RFID tag which does not require a battery significantly simplifies the apparatus and enables a highly-reliable column temperature control.

The column temperature monitoring apparatus according to the present invention may be configured as a module which can be attached to an existing column and existing constant temperature bath. Alternatively, it may be configured in various ways, such as: a combination of a constant temperature bath in which the processor's function is installed and a sensor unit attachable to an existing column; or the sensor unit may be integrated into the column itself.

A chromatographic apparatus according to the present invention uses the aforementioned column temperature monitoring apparatus and includes:

a heating unit for heating a metal block placed in such a manner as to contact with a column or for heating a space inside a constant temperature bath containing the column; and

a controller for controlling a heating by the heating unit based on the temperature information obtained by the processor.

The controller may be realized a personal computer, as its hardware resource, and software for the control, whereby the above mentioned function is achieved by the software running on the personal computer. As a matter of course, compared to the conventional apparatus in which the temperature of the air in the constant temperature bath or the temperature of the metal block is used, the discrepancy from the control target value, the responsiveness to the temperature change in the heating unit, and other factors are different in the case of the apparatus of the present invention in which the temperature of the outer surface of the column is monitored. Therefore, the control program should be made to take such differences into account.

With the column temperature monitoring apparatus according to the present invention, the temperature of the air inside a constant temperature bath or the temperature of a metal block is not detected as in a conventional manner, but the temperature of the column's outer surface is directly detected, and a temperature control based on this detected temperature is performed. This diminishes the discrepancy between the actual column temperature and the control target value, and the column temperature can be kept constant with high accuracy in performing a constant temperature analysis, for example. In addition, the accuracy of the absolute value of the temperature is improved than before. As a result, the reproducibility and accuracy of analyses is improved, and the analysis conditions of a plurality of chromatographic apparatuses become more consistent. Therefore, the accuracy of the analysis in comparing the analysis results obtained by a plurality of chromatographic apparatuses is also enhanced.

In the case where the temperatures of the outer surface of a column along its length are detected and displayed, a user can easily know the temperature gradient inside the column. Thereby, the user can determine whether or not a pre-heating is adequate, and if necessary, an appropriate action can be taken, such as changing the length of the pre-heating path. As a result, a high analysis reproducibility can be realized.

### BRIEF DESCRIPTION OF THE DRAWINGS

FIG. 1 is a configuration diagram of the main portion of the LC apparatus according to an embodiment of the present invention.

FIG. 2 shows a configuration example (first embodiment) of the sensor unit and temperature controlling/processing unit.

FIG. 3 shows a configuration example (second embodiment) of the sensor unit and temperature controlling/processing unit.

FIG. 4 shows a configuration example (third embodiment) of the sensor unit and temperature controlling/processing unit.

FIG. 5 shows a configuration example (fourth embodiment) of the sensor unit and temperature controlling/processing unit.

FIG. 6 shows a configuration example (fifth embodiment) of the sensor unit and temperature controlling/processing unit.

FIG. 7 schematically shows an example of attachment of the sensor unit to the column.

FIG. 8 schematically shows an example of attachment of the sensor unit to the column.

FIG. 9 is a diagram showing a configuration example of the case where a plurality of sensor units are attached to the column.

### EXPLANATION OF THE NUMERALS

1 . . . . Mobile Phase Container
2 . . . . Liquid Sending Pump
3 . . . . Auto Sampler
4 . . . . Column
5 . . . . Constant Temperature Bath
51 . . . . Heater
52 . . . Fan
53 . . . . Temperature Sensor
6 . . . . Detector
7 . . . . Controller/Processor
8 . . . . Input Unit
9 . . . . Display Unit
10, 10A, 10B . . . . Sensor Unit
11 . . . . Temperature Sensor
12 . . . A/D Conversion Circuit Unit
13 . . . CPU
14 . . . . Wireless Transceiver
15 . . . RFID Tag
151 . . . . Antenna
152 . . . . Nonvolatile Memory
20 . . . . Temperature Controlling/Processing Unit
21 . . . CPU
24 . . . FRID Reader
30 . . . . Communication Path

### DETAILED DESCRIPTION OF A PREFERRED EMBODIMENT

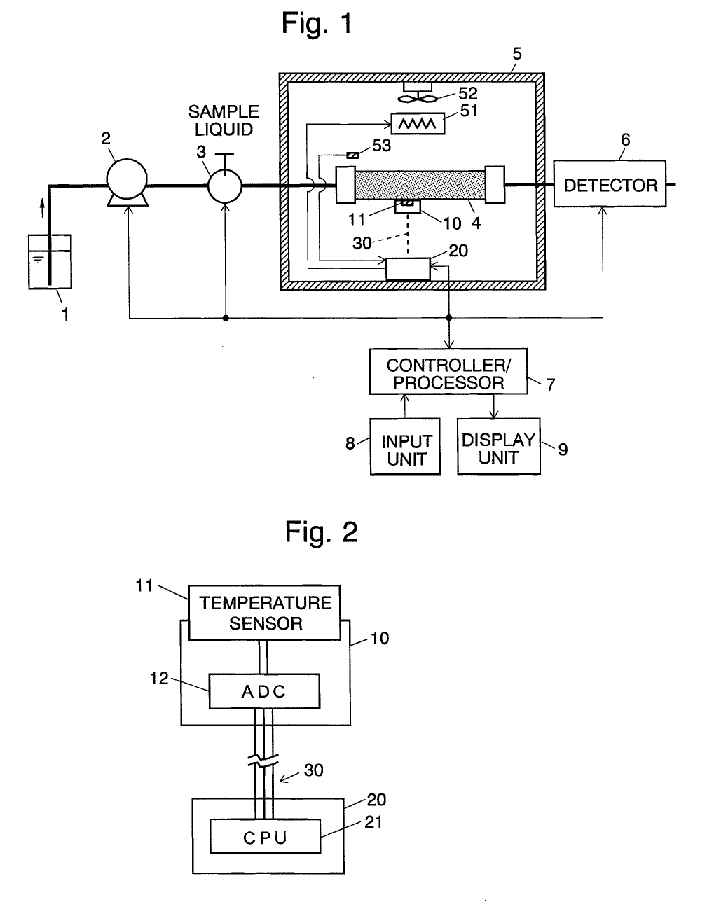

A liquid chromatograph (LC) apparatus using a column temperature monitoring apparatus which is an embodiment of the present invention will be described with reference to accompanying drawings. FIG. 1 is a configuration diagram of the main portion of the LC apparatus.

In this LC apparatus, a liquid sending pump 2 sucks the mobile phase held in a mobile phase container 1 and sends the mobile phase at a constant flow rate to a column 4 through an auto sampler 3. The auto sampler 3 includes an injector, and selects a specified sample from among a number of samples which have been prepared in advance and injects the sample into the mobile phase. The injected sample carried by the mobile phase is introduced into the column 4. While passing through the column 4, the sample is temporally separated, and eluted therefrom. As will be described, the column 4 is contained in a constant temperature bath 5 which can be controlled to be at a constant temperature. The liquid eluted from the column 4 is introduced into a detector 6, such as an absorption spectrophotometer, and detection signals corresponding to each component of the sample in the eluted liquid are taken out with time.

Inside the constant temperature bath 5, a heater 51 for heating the air in the constant temperature bath 5 and a fan 52 for agitating the heated air are provided. The heater 51 produces heat by receiving a heating current from a temperature controlling/processing unit 20 which will be described later. The temperature of the air inside the constant temperature bath 5 is detected by a temperature sensor 53, and the temperature information is sent to the temperature controlling/processing unit 20. In place of the heater 51, other heat sources such as a Peltier device can be used. Although an air circulation method is employed in this example, a heat block method can also be employed by providing a metal block with high thermal conductivity in such a manner as to touch the column 4 and heating the metal block by a heater or other devices.

Outside the constant temperature bath 5, a controller/processor 7 for integrally controlling the entire units to perform an LC analysis, and for receiving detection signals from the detector 6 to process them, is provided. To the controller/processor 7, an input unit 8 and a display unit 9 are connected, where the input unit 8 allows a user to set analysis conditions and other parameters, and the display unit 9 displays the set analysis conditions, the progress of the analysis, the analysis results, and other information. In general, the controller/processor 7 is constructed on a personal computer, and can perform a control and processing by executing dedicated controlling/processing software installed in the computer. In performing a constant temperature analysis in which the temperature of the column 4 is kept constant or a temperature gradient analysis in which an analysis is performed while increasing the temperature, the controller/processor 7 indicates a predetermined temperature program to the temperature controlling/processing unit 20, and the temperature controlling/processing unit 20 controls the heating current supplied to the heater 51 so that the actual column temperature becomes the target temperature indicated by the temperature program.

The characteristic configuration of the LC apparatus of the present embodiment is that: a sensor unit 10 is attached on the outer surface of the column 4; and the temperature controlling/processing unit 20 is placed at an appropriate position in the constant temperature bath 5. The sensor unit 10 and the temperature controlling/processing unit 20 are connected via a communication path 30. The sensor unit 10 corresponds to the sensor unit in the column temperature monitoring apparatus according to the present invention, the temperature controlling/processing unit 20 to the processor, and the communication path 30 to the information transmission unit. The sensor unit 10 includes at least a temperature sensor 11 composed of a thermistor and other elements, and the sensor unit 10 is attached to the column 4 in such a manner that a heat-sensitive portion of the temperature sensor 11 is in contact with the outer surface of the column 4.

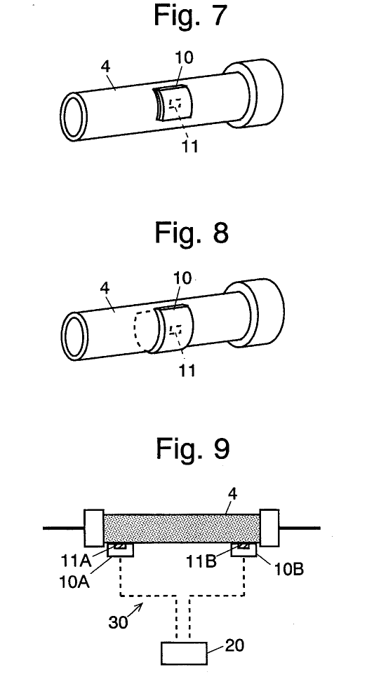

FIGS. 7 and 8 are a schematic diagram illustrating an attachment example of the sensor unit 10 to the column 4. In the example of FIG. 7, the sensor unit 10 has an adhesive portion or an suction portion, and the sensor unit 10 is attached to the outer surface of the column 4 via the adhesive portion or the suction portion. In the example of FIG. 8, the sensor unit 10 has a holder having an approximately U-shaped cross section for holding the outer surface of the column 4, and by mounting this holder on the outer surface of the column 4, the sensor unit 10 is firmly attached to the column 4. Of course, the attachment method of the column 4 to the sensor unit 10 is not limited to those examples.

Since, as previously described, the temperature sensor 11 has direct contact with the outer surface of the column 4, it is possible to obtain temperature information which is close to the internal temperature of the column 4 by this temperature sensor 11. Basically, the temperature information is sent to the temperature controlling/processing unit 20 via the communication path 30, and the temperature controlling/processing unit 20 recognizes the latest temperature and controls the heating current to attain the target temperature indicated from the controller/processor 7. However, to be more precise, the sensor unit 10, temperature controlling/processing unit 20, and communication path 30 can have a variety of configurations as follows. Such a variety of configurations will be described with reference to FIGS. 2 through 6.

### (First Configuration)

In the case where the temperature sensor 11 is a thermistor, the temperature sensor only produces a resistance change in accordance with temperature. Therefore, in order to read the resistance change as temperature information, an A/D conversion circuit unit (ADC) 12 and a central processing unit (CPU) are required, where the ADC 12 changes the resistance value of the temperature sensor 11 to a voltage value and then changes the analog voltage value to a digital value, and the CPU controls the A/D conversion circuit unit 12. In the first configuration illustrated in FIG. 2, the temperature sensor 11 and the A/D conversion circuit unit 12 are installed in the sensor unit 10. The function of a CPU for controlling the A/D conversion circuit unit 12 is performed by the CPU 21 installed in the temperature controlling/processing unit 20. The communication path 30 is a wired cable which deals with the control signal sent from the CPU 21 to the A/D conversion circuit unit 12 and the detected temperature data sent from the A/D conversion circuit unit 12 to the CPU 21.

Columns are normally consumables, and should be used and changed appropriately in accordance with analysis conditions. Therefore, in the case where the communication path 30 is a wire as previously described, it is preferable that the wire is connected to the sensor unit 10 and the temperature controlling/processing unit 20 via connectors at respective ends in order to facilitate the attachment and detachment of the wire.

### (Second Configuration)

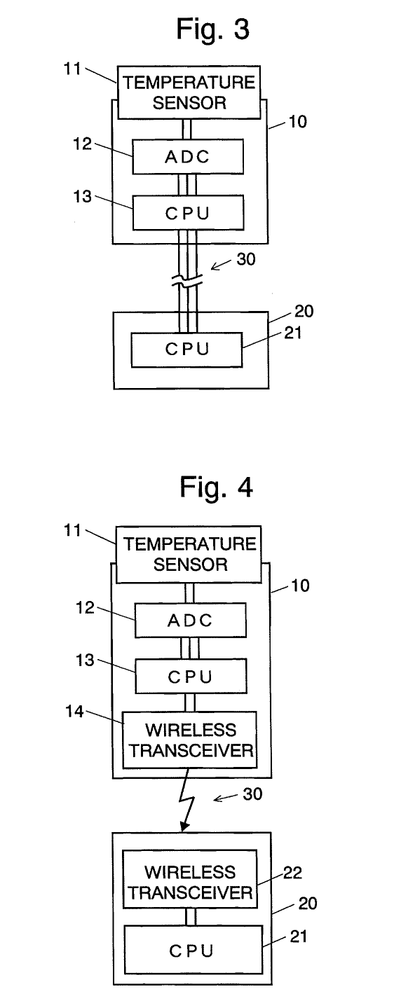

In the second configuration illustrated in FIG. 3, the function of controlling the A/D conversion circuit unit 12 is withdrawn from the CPU 21 installed in the temperature controlling/processing unit 20, and is assigned to another CPU 13 installed in the sensor unit 10. In this case, a mutual communication is required between the CPU 13 in the sensor unit 10 and the CPU 21 in the temperature controlling/processing unit 20 via the communication path 30. For such a communication, a wire communication compliant with RS-232C, for example, can be used.

### (Third Configuration)

The third configuration illustrated in FIG. 4 is an example in the case where the communication path 30 is unwired. As the communication path 30, Infrared Data Association (IrDA) using infrared light, Bluetooth (registered trademark) using a radio wave, or other methods can be used. For this, wireless transceivers 14 and 22 are respectively provided for the sensor unit 10 and for the temperature controlling/processing unit 20.

### (Fourth Configuration)

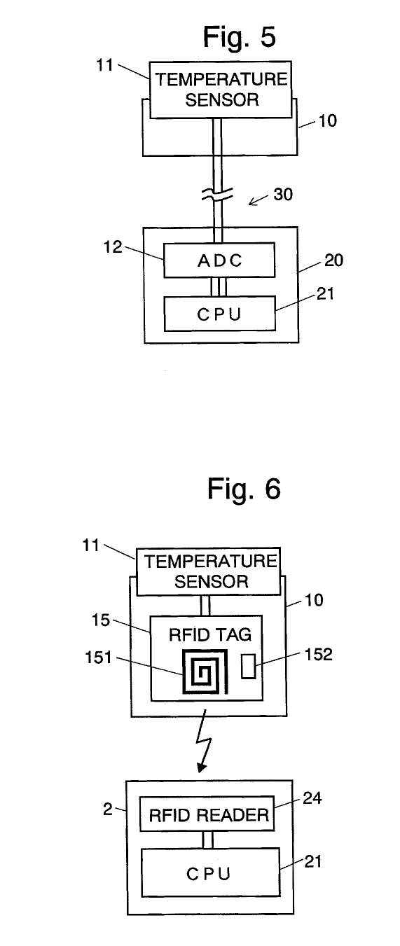

In the fourth configuration illustrated in FIG. 5, only a temperature sensor 11 is basically installed in the temperature sensor unit 10, and the A/D conversion circuit unit 12 and subsequent circuits are installed in the temperature controlling/processing unit 20. The communication path 30 is constructed by a signal line drawn from the temperature sensor 11, and this signal line is connected to the A/D conversion circuit unit 12 on the side of the temperature controlling/processing unit 20. Although this configuration is disadvantageous in respect of accuracy of the temperature detected by the temperature sensor 11, it is advantageous in decreasing the cost since the number of parts used is small and the usage of expensive parts can be reduced.

### (Fifth Configuration)

Since the distance between the sensor unit 10 and the temperature controlling/processing unit 20 is small, the communication path 30 requires only a short-distance communication. Therefore, a communication by a contactless data carrier system can be used. In the fifth configuration illustrated in FIG. 6, the temperature sensor 11 and an RFID tag 15 are installed in the sensor unit 10, and an RFID reader 24 is installed in the temperature controlling/processing unit 20. The temperature information detected in the temperature sensor 11 is sent out via an antenna 151 in the RFID tag 15. The RFID reader 24 reads the information thus sent under the control of the CPU 21.

As the RFID tag 15, a tag described in Japanese Unexamined Patent Application Publication No. 2005-327104 can be used for example. In addition, an RFID tag to which a temperature sensor is integrated has been developed (an example of such an RFID tag was published as a press release on the website of Oki Electric Industry Co., Ltd., dated Apr. 19, 2006) and the use of such an element device facilitates the configuration.

In the configuration example illustrated in FIG. 1, only one sensor unit 10 is attached to the column 4. However, by attaching a plurality of sensor units to one column 4, it is possible to measure each temperature in different areas along the column 4. FIG. 9 is an example in which sensor unit 10A and 10B are respectively attached near the entrance and near the exit of the column 4. By attaching a plurality of sensor units as this example, it is possible to know the temperature gradient along the length of the column 4. Thereby, in performing a pre-heating before the column 4 for example, it is possible to determine that a pre-heating is insufficient in the case where the temperature near the entrance of the column 4 is significantly lower than that near the exit. Basically, the configuration of the sensor unit 10 and the temperature controlling/processing unit 20 can be any form of the previous-described configurations. However, a wired communication path 30 complicates the wiring, and makes it hard to deal with. Hence, to simplify the configuration, a wireless configuration, as in the third or firth configuration, and supporting a one-to-many communication may be used.

The sensor unit 10 and the temperature controlling/processing unit 20 in the aforementioned configurations are endowed with nothing other than a temperature monitoring function. However, they may be endowed with other functions such as the column management function, in which an IC chip imprinted with an ID unique to every column is attached, and the column's usage history or other information using the ID may be managed on a server. For example, in the configuration of the aforementioned second embodiment, a nonvolatile memory which can be controlled by the CPU 13 may be provided in the sensor unit 10 and an identification information such as an ID unique to a column may be written in this nonvolatile memory. Thereby, the controller/processor 7 can read out the identification information via the CPU 21 and CPU 13 according to necessity and can manage the column's usage history and other data corresponding to the identification information.

In the configuration of the fifth embodiment which was previously described, the RFID tag 15 generally has a nonvolatile memory 152 into which a certain amount of information can be written. Further, an RFID tag, by itself, is assigned with a unique ID number with which an individual recognition can be made. Given such factors, using the identification information which has been written into such a nonvolatile memory and the RFID tag's unique number, the usage history of the column mounting the RFID tag and other information can be managed.

As described above, in the LC apparatus of the aforementioned embodiments, since a temperature control can be performed based on the detected temperature of the outer surface of the column 4, which is close to the temperature inside the actual column, a more accurate temperature control than before can be realized. However, compared to the temperature sensor 53 provided in the constant temperature bath 5 for detecting the temperature of the air inside the bath, the temperature sensor 11 of the sensor unit 10 is more distant from the heater 51. Given this factor, in the case where the difference between the temperature detected by the temperature sensor 11 and the temperature detected by the temperature sensor 53 is large, or in the case where the difference between the target temperature of a temperature control and the detected temperatures by the temperature sensors 11 and 53 is large, a temperature control based on the temperature detected by the temperature sensor 53 may be first performed, and then, after the temperature difference is decreased, the temperature control may be changed to the temperature control based on the temperature sensor 11. In the case where the difference between the temperature detected by the temperature sensor 11 and the temperature detected by the temperature sensor 53 does not fall below a predetermined value even after a predetermined period of time has elapsed from the starting of the temperature control, a warning can be displayed as there is something abnormal.

It is preferable, in the controller/processor 7, while an LC analysis is in progress, that the column temperature information is received from the temperature controlling/processing unit 20 at predetermined time intervals, recorded, and the information is saved as a temperature history (or log) along with the chromatogram data of an LC analysis result. With this configuration, it is possible to check whether or not a column temperature was normal by checking the temperature history in the case where an analysis result contains something questionable. In addition, with the change in the analysis condition, such as a change of the setting flow rate in the liquid sending pump 2 or the change of the setting temperature in the constant temperature bath 5, how the column temperature has actually changed can be easily checked.

It should be noted that the embodiments described thus far are merely an example of the present invention, and it is evident that any modification, adjustment, and addition properly made in accordance with the spirit of the present invention will be included in the scope of the claims of the present application.

What is claimed is:

1. A column temperature monitoring apparatus for controlling a temperature of a column of a liquid chromatograph or a gas chromatograph, comprising:
a) a sensor unit directly attached to an outer surface of the column and including a temperature detection unit for obtaining temperature information corresponding to a temperature of the outer surface of the column;
b) a processor provided at a position distant from the sensor unit, for processing the temperature information obtained by the temperature detection unit; and
c) an information transmission unit for connecting the sensor unit and the processor by wire or wirelessly.

2. The column temperature monitoring apparatus according to claim 1, wherein the sensor units are provided in a plurality, and the processor is commonly provided for the plurality of sensor units.

3. The column temperature monitoring apparatus according to claim 1, wherein the sensor unit includes a holding unit for fixing the sensor unit on an existing column in such a manner that the temperature detection unit is in contact with the outer surface of the column.

4. The column temperature monitoring apparatus according to claim 1, wherein the column includes a constant temperature bath in which the column is contained, and the processor is provided in the constant temperature bath.

5. The column temperature monitoring apparatus according to claim 1, wherein the sensor unit includes a reading unit for reading the temperature information obtained by the temperature detection unit and converting the temperature information into an electric signal in accordance with the temperature.

6. The column temperature monitoring apparatus according to claim 1, further including an information retention unit integrated with the sensor unit, for retaining column identification information for specifying the column.

7. The column temperature monitoring apparatus according to claim 1, wherein the sensor unit uses a radio frequency identification (RFID) tag.

8. A chromatographic apparatus using the column temperature monitoring apparatus according to claim 1, comprising:
a heating unit for heating a metal block placed in such a manner as to contact with the column or for heating a space inside a constant temperature bath containing the column; and
a controller for controlling a heating by the heating unit based on the temperature information obtained by the processor.

9. A chromatographic apparatus using the column temperature monitoring apparatus according to claim 2, comprising:
a heating unit for heating a metal block placed in such a manner as to contact with the column or for heating a space inside a constant temperature bath containing the column; and
a controller for controlling a heating by the heating unit based on the temperature information obtained by the processor.

10. A chromatographic apparatus using the column temperature monitoring apparatus according to claim 3, comprising:
a heating unit for heating a metal block placed in such a manner as to contact with the column or for heating a space inside a constant temperature bath containing the column; and
a controller for controlling a heating by the heating unit based on the temperature information obtained by the processor.

11. A chromatographic apparatus using the column temperature monitoring apparatus according to claim 4, comprising:
a heating unit for heating a space inside a constant temperature bath containing the column; and
a controller for controlling a heating by the heating unit based on the temperature information obtained by the processor.

12. A chromatographic apparatus using the column temperature monitoring apparatus according to claim 5, comprising:
a heating unit for heating a metal block placed in such a manner as to contact with the column or for heating a space inside a constant temperature bath containing the column; and
a controller for controlling a heating by the heating unit based on the temperature information obtained by the processor.

13. A chromatographic apparatus using the column temperature monitoring apparatus according to claim 6, comprising:
a heating unit for heating a metal block placed in such a manner as to contact with the column or for heating a space inside a constant temperature bath containing the column; and
a controller for controlling a heating by the heating unit based on the temperature information obtained by the processor.

14. A chromatographic apparatus using the column temperature monitoring apparatus according to claim 7, comprising:
a heating unit for heating a metal block placed in such a manner as to contact with the column or for heating a space inside a constant temperature bath containing the column; and
a controller for controlling a heating by the heating unit based on the temperature information obtained by the processor.
